(19) United States
(12) Patent Application Publication
(10) Pub. No.: US 2016/0023602 A1
(43) Pub. Date: Jan. 28, 2016

(54) SYSTEM AND METHOD FOR CONTROLING THE OPERATION OF A WEARABLE COMPUTING DEVICE BASED ON ONE OR MORE TRANSMISSION MODES OF A VEHICLE

(71) Applicant: Honda Motor Co., Ltd., Tokyo (JP)

(72) Inventor: Gokula Krishnan, San Jose, CA (US)

(21) Appl. No.: 14/341,900

(22) Filed: Jul. 28, 2014

(51) Int. Cl. B60R 1/00; G09G 5/00; G02B 27/01

(52) U.S. Cl. CPC B60R 1/00; G02B 27/017; G09G 5/003; G02B 2027/0178; B60R 2300/205; B60R 2300/207; B60R 2300/70; B60R 2300/8066; B60R 2300/8086; G09G 2320/10; G09G 2380/10

(57) ABSTRACT

A method and system for controlling the operation of a wearable computing device based on one or more transmission modes of a vehicle. The method and system include communicating with the wearable computing device. The method and system additionally include identifying a user classification category. Additionally, the method and system include determining a transmission mode of the vehicle. The method and system also include controlling the operation of the wearable computing device based on the user classification category and the transmission mode of the vehicle.

### BACKGROUND

Wearable computing devices are increasingly becoming popular as they are implemented with a variety of applications, services and interfaces. Typically, wearable computing devices include a display to present data. For example, data can be presented on an optical head mounted display of a wearable computing device. The optical head mounted display allows a user to view application and interface data based on the user's point of reference. In some instances, the optical head mounted display can include an operating system with default applications that allow a user to control the applications and other functions, devices or hardware associated with the wearable computing device.

In the context of a vehicle, the use of in-vehicle technology, connected vehicles (e.g., to a portable device, a wearable computing device, other vehicles) and new interactive vehicle systems, are presenting drivers with more distractions and challenges to the task of driving. In particular, many of these systems require the driver to divert his or her attention from the roadway. In some cases, vehicle safety systems also can cause undue driver distraction. For example, backup camera and side view camera systems can require the driver to look at indicators or screens that appear on center stack screens, side view/rear view mirrors, or on the vehicle dashboard. Portable devices and/or wearable computing devices can be configured in the context of a vehicle to assist driving operations while keeping the driver and vehicle occupants safe.

### SUMMARY

According to one aspect, a method for controlling the operation of a wearable computing device based on one or more transmission modes of a vehicle includes communicating with the wearable computing device and identifying a user classification category. The method includes determining a transmission mode of the vehicle and controlling the operation of the wearable computing device based on the user classification category and the transmission mode of the vehicle.

According to a further aspect, a system for controlling the operation of a wearable computing device based on one or more transmission modes of a vehicle includes a vehicle transmission mode interface application that is executed on the wearable computing device and is operably connected for computer communication with the vehicle. The vehicle transmission mode interface application includes a classification module that identifies a user classification category of the user wearing the wearing computing device. The vehicle transmission mode interface application includes a transmission mode determinant module that determines a transmission mode of the vehicle. The vehicle transmission mode interface application includes optical display module that controls the operation of the wearable computing device based on the user classification category and the transmission mode of the vehicle.

According to still another aspect, a computer readable medium including instructions that when executed by a processor execute a method for controlling the operation of a wearable computing device based on one or more transmission modes of a vehicle, the method includes communicating with the wearable computing device and identifying a user classification category. The method includes determining a transmission mode of the vehicle and controlling the operation of the wearable computing device based on the user classification category and the transmission mode of the vehicle.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, can be best understood by reference to the following detailed description of illustrative embodiments when read in conjunction with the accompanying drawings, wherein:

FIG. 1 is a schematic view of an exemplary operating environment of a system for controlling the operation of a wearable computing device based on one or more transmission modes of a vehicle and exemplary methods according to an embodiment;

FIG. 2 is a process flow diagram of a method utilized by an exemplary embodiment of the transmission determinant module of FIG. 1 to determine a transmission mode of the vehicle and the optical display module of FIG. 1 to control the optical display of the wearable computing device according to an embodiment;

FIG. 3 is a screenshot of an exemplary optical display of a wearable computing device providing a point of interest user interface according to an embodiment; and

FIG. 4 is a process flow diagram of a method utilized by an exemplary embodiment of the vehicle transmission mode information application for controlling the operation of a wearable computing device based on one or more transmission modes of a vehicle from the operating environment of FIG. 1.

### DETAILED DESCRIPTION

The following includes definitions of selected terms employed herein. The definitions include various examples and/or forms of components that fall within the scope of a term and that can be used for implementation. The examples are not intended to be limiting.

A “bus,’ as used herein, refers to an interconnected architecture that is operably connected to transfer data between computer components within a singular or multiple systems. The bus can be a memory bus, a memory controller, a peripheral bus, an external bus, a crossbar switch, and/or a local bus, among others. The bus can also be a vehicle bus that interconnects components inside a vehicle using protocols such as Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “input device” as used herein can include devices for controlling different vehicle features which are include various vehicle components, systems, and subsystems. The term “input device” includes, but it not limited to: push buttons, rotary knobs, and the like. The term “input device” additionally includes graphical input controls that take place within a user interface which can be displayed by various types of mechanisms such as software and hardware based controls, interfaces, or plug and play devices.

A “memory,” as used herein can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

A “module”, as used herein, includes, but is not limited to, hardware, firmware, software in execution on a machine, and/or combinations of each to perform a function(s) or an action(s), and/or to cause a function or action from another module, method, and/or system. A module can include a software controlled microprocessor, a discrete logic circuit, an analog circuit, a digital circuit, a programmed logic device, a memory device containing executing instructions, and so on.

An “operable connection,” as used herein can include a connection by which entities are “operably connected”, is one in which signals, physical communications, and/or logical communications can be sent and/or received. An operable connection can include a physical interface, a data interface and/or an electrical interface.

An “output device” as used herein can include devices that can derive from vehicle components, systems, subsystems, and electronic devices. The term “output devices” includes, but is not limited to: display devices, and other devices for outputting information and functions.

A “processor”, as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “vehicle”, as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, personal watercraft, and aircraft. In some cases, a motor vehicle includes one or more engines.

A “vehicle system”, as used herein can include, but are not limited to, any automatic or manual systems that can be used to enhance the vehicle, driving and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, among others.

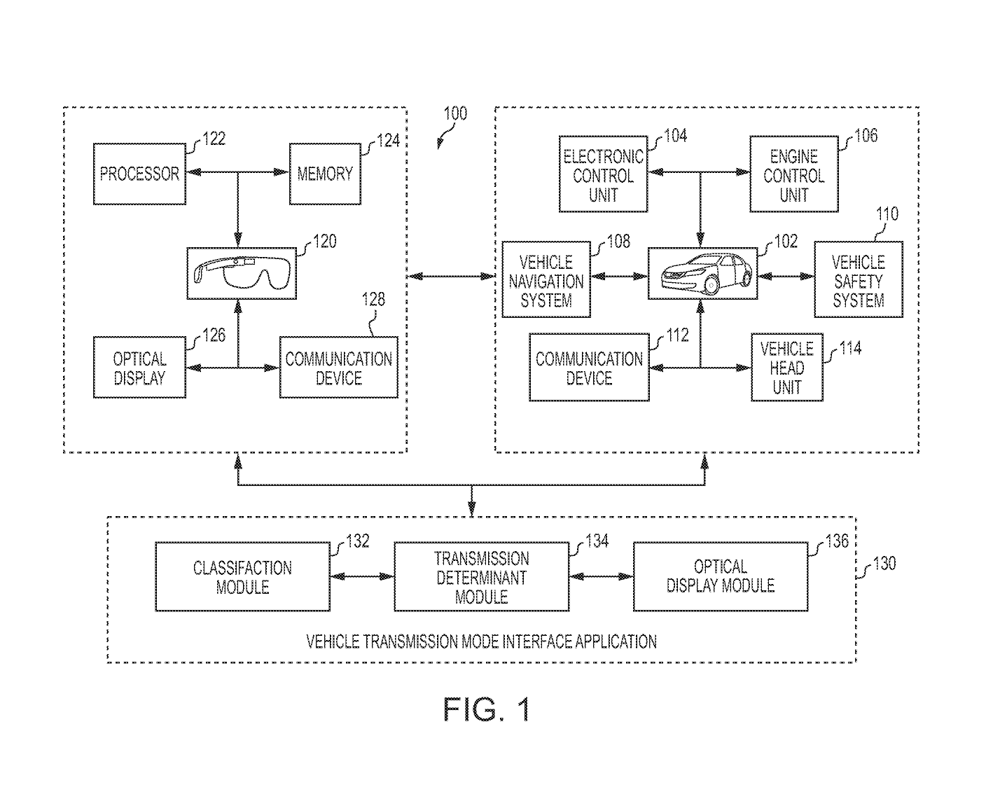

Referring now to the drawings, the showings are for purposes of illustrating one or more exemplary embodiments and not for purposes of limiting the same, FIG. 1 shows a schematic view of an exemplary operating environment of system 100 for controlling the operation of a wearable computing device based on one or more transmission modes of a vehicle and exemplary methods according to an embodiment. The components of the system 100, as well as the components of other systems, hardware architectures and software architectures discussed herein, can be combined, omitted or organized into different architecture for various embodiments. However, the exemplary embodiments discussed herein focus on the environment as illustrated in FIG. 1, with corresponding system components, and related methods.

As shown in the illustrated embodiment of FIG. 1, a vehicle 102 can include an electronic control unit 104 that operably controls a plurality of vehicle systems. The vehicle systems can include, but are not limited to, a vehicle navigation system 108 and a vehicle safety system 110. The vehicle navigation system 108 is connected to a vehicle GPS sensor (not shown) that can also be connected to the electronic control unit 104 to localize (i.e., determine the GPS coordinates) the vehicle 102. The vehicle safety system 110 can include various vehicle safety features that are connected to a plurality of vehicle cameras (not shown). The vehicle safety features can include but are not limited to vehicle backup assist, blind spot monitoring assist, and driving assist features. The plurality of vehicle safety cameras can include but are not limited to backup view cameras, side view cameras, front view cameras, and the like that are selectively utilized by the vehicle safety features of the vehicle safety system 110.

The electronic control unit 104 generally provides processing, communication and control of vehicle systems and can include a processor, memory, an interface circuit, and bus lines for transferring data, however, for simplicity, these components are not shown. The electronic control unit 104 can consist of various modules (not shown) to control various vehicle systems and vehicle components of the vehicle 102. The electronic control unit 104 can be connected to input sensors (not shown) that provide the electronic control unit 104 with data related to various vehicle systems and components.

The vehicle 102 can also include a communication device 112 for sending data internally within the vehicle 102 to the vehicle systems. Additionally, the communication device 112 can be utilized for sending data externally to connected devices that include, but are not limited to, a wearable computing device 120, and other devices (not shown), for example, portable electronic devices, vehicle components (e.g., vehicle key fob), and other vehicles. Thus, the wearable computing device 120 and the vehicle 102 are operable connected for computer communication to communicate at least one of vehicle system data, vehicle transmission data, vehicle engine data and vehicle transmission mode interface application data. Exemplary wearable computing devices will be discussed in more detailed below, but can include, virtual headsets, watches, glasses, bracelets, and headwear, among other types of wearables. The communication device 112 included within the vehicle 102 is also connected to the electronic control unit 104 as well as other components and systems.

The communication device 112 can be capable of providing wired or wireless computer communications utilizing various protocols to send/receive non-transitory signals internally to features and systems within the vehicle 102 and to external devices. Generally, these protocols include a wireless system (e.g., IEEE 802.11, IEEE 802.15.1 (Bluetooth)), a near field communication system (NFC) (e.g., ISO 13157), a local area network (LAN), and/or a point-to-point system. Additionally, the communication device 112 of the vehicle 102 can be operably connected for internal computer communications via a bus (e.g., a Controller Area Network (CAN) or a Local Interconnect Network (LIN) protocol bus). The connections can be in-vehicle or exterior cellular connections provided by connected devices (e.g., portable electronic devices) to facilitate data input and output between the electronic control unit 104 and vehicle systems and components.

The vehicle 102 can also include an engine control unit 106 that can control and provide data regarding the vehicle speed, idle speed, engine throttle positions, and transmission modes of the vehicle 102. The engine control unit 106 can include internal processing memory, an interface circuit, and bus lines for transferring data, sending commands, receiving data, and communicating with vehicle components, however, for simplicity, these components are not shown. The engine control unit 106 can also determine the status of vehicle components that are operably connected to the engine of the vehicle 102. In an exemplary embodiment, the engine control unit 106 can determine the transmission mode of the vehicle 102 based on the transmission mode or transmission gear of a vehicle transmission system (i.e., powertrain system) (not shown).

In an exemplary embodiment, a vehicle 102 that includes an automatic transmission, an automatic transmission mode can be selected by a driver, for example, when a driver shifts a gear shifter. The transmission modes can include a plurality of transmission modes depending on the type of transmission and type of the vehicle 102. In one embodiment, the transmission modes include a park (P) transmission mode, a reverse (R) transmission mode, a neutral (N) transmission mode, a drive (D) transmission mode, a second drive (D2) transmission mode, an emergency brake (B) mode, a snow mode (S), a sport mode (SPT), a manual transmission gear mode, among others. In an alternate embodiment, the vehicle 102 can include a manual transmission, and manual transmission modes that are selected by the driver.

In an exemplary embodiment, a transmission control unit (not shown) can also be included within the vehicle 102 as a separate component of an automatic transmission of the vehicle 102 that is operably connected to the engine control unit 106 to provide data regarding the automatic vehicle transmission system and specifically the transmission modes of the vehicle 102. The engine control unit 106 and/or the transmission control unit can be operably connected to the electronic control unit 104 and can provide data to the electronic control unit 104 and/or vehicle systems with regards to the transmission mode of the vehicle 102. As an illustrative example, if the vehicle 102 is put into the drive (D) transmission mode (e.g., a user shifts a gear into drive (D) mode), the transmission control unit or the engine control unit 106 can transmit the transmission mode information to the electronic control unit 104 to indicate that the vehicle is in a drive (D) transmission mode. The electronic control unit 104 can forward this information to internal vehicle systems or external applications such as a vehicle transmission mode interface application 130 described in more detail below.

In an exemplary embodiment, the electronic control unit 104 can transmit the transmission mode information directly to a vehicle head unit 114. The vehicle head unit 114 can include internal processing memory, an interface circuit, and bus lines for transferring data, sending commands, and communicating with the vehicle systems, however, for simplicity, these components are not shown. In one embodiment, the internal processing memory of the vehicle head unit 114 stores data that is utilized by numerous vehicle systems including the vehicle navigation system 108 and the vehicle safety system 110. For example, the vehicle head unit 114 can store software application data related to the vehicle navigation system 108 that includes map data, user interfaces, and points of interest databases utilized by the vehicle navigation system 108. In addition to vehicle systems data, the vehicle head unit 114 also stores software applications that are not included as part of vehicle systems.

Generally, the wearable computing device 120 of the vehicle transmission mode wearable interface system 100 can be a head mounted computing display device that includes an optical display 126 which enables a user to view a virtual and/or augmented reality image of the real world environment from the user's point of reference. In other embodiments, the wearable computing device can be a virtual headset, a watch, a bracelet, a piece of headwear, among others, each of which typically include or are connected to a display. The wearable computing device 120 is controlled by a processor 122 that provides processing and executes computing functions as required by an operating system and/or applications installed onto a memory 124 and/or external devices that are connected to the wearable computing device 120 through a communication device 128. The wearable computing device 120 can also include an input component (not shown) which enables user input. For example, the input component can include input buttons and/or a touch-sensitive strip that receives user inputs in order to perform functions of an operating system and various applications executed through the wearable computing device 120.

In one embodiment, the wearable computing device 120 employs sensors for monitoring six degrees of freedom that allows the optical display 126 to align virtual information to the physical world and adjust accordingly with the user's head movements. In an exemplary embodiment, the optical display 126 has the capability of reflecting projected/augmented images and allows the user to see through the optical display 126 at real world objects that are virtually augmented. In one embodiment, the wearable computing device 120 includes one or more cameras (not shown) that capture real time images of the real world environment from the user's perspective and intercept the real world view to be augmented through the optical display 126. In an alternate embodiment, the wearable computing device 120 can receive real time images from external cameras (e.g., cameras included within the vehicle 102 (e.g., a back view camera, a side view camera, a front view camera), cameras included as part of a connected portable electronic device). In another embodiment, the wearable computing device 120 can receive computer generated or computer modified images of a real time environment.

In an exemplary embodiment, the wearable computing device 120 also includes a communication device 128 that can be utilized to provide external applications (i.e., applications not stored on the wearable computing device 120) and internet resources to the user. In addition, the communication device 128 provides peer-to-peer (P2P) connections over to send/receive non-transitory signals with the communication device 112 of the vehicle 102 to be utilized by software applications installed within the vehicle head unit 114. For example, the communication device 128 of wearable computing device 120 can be utilized to communicate with the vehicle head unit 114 in order to access and execute the vehicle transmission mode interface application 130.

In the embodiment shown in FIG. 1, the communication device 128 of the wearable computing device 120 can also be utilized to provide P2P communications to send and receive data directly with the electronic control unit 104 in order for the vehicle transmission mode interface application 130 to obtain vehicle transmission mode data. The vehicle transmission interface application 130 can utilize the vehicle transmission mode data sent via the P2P communications to provide user interfaces, systems, and applications to the user that correspond to each transmission mode of the vehicle 102 through the wearable computing device 120.

In an exemplary embodiment, the wearable computing device 120 can connect to the vehicle 102 via a Bluetooth™ connection that can be utilized to provide data connections to support communication of application data, and/or utilize applications residing within the memory 124 of the wearable computing device 120. Specifically, in the exemplary embodiment discussed above, the wearable computing device 120 connects via Bluetooth™ to the communication device 112 of the vehicle 102 and uploads the vehicle transmission mode interface application 130 from the vehicle head unit 114 to be executed on the wearable computing device 120. In an embodiment, an alternate type of wireless (e.g., Wi-Fi) connection or a wired (e.g., USB) connection can be utilized to connect the wearable computing device 120 to the vehicle head unit 114.

As discussed above, in an exemplary embodiment, the vehicle transmission mode interface application 130 is executed on a wearable computing device 120 that is operably connected for computer communication with the vehicle 102. The vehicle transmission mode interface application 130 can include various modules for controlling the operation of the wearable computing device 120, as will be discussed in more detail herein. In one embodiment, the vehicle transmission mode interface application 130 is a software application that is installed directly onto the vehicle head unit 114. In one embodiment, the vehicle transmission mode interface application 130 and/or one or more of the components of the vehicle transmission mode interface application 130 can be installed on the memory 124 of the wearable computing device 120. In yet an alternate embodiment, the vehicle transmission mode interface application 130 can be stored on a portable electronic device (not show) that communicates directly with the electronic control unit 104 or of the vehicle 102 through the communication device 112 and the wearable computing device 120 through the communication device 128. In another embodiment, the vehicle transmission mode interface application 130 can include a web based application or a cloud based application that resides on an external web server (not shown) and is accessed by the communication device 128 of the wearable computing device 120.

The vehicle transmission mode interface application 130 can be initialized by user input on an application menu user interface shown on the wearable computing device 120, for example, on the optical display 126. In one embodiment, the vehicle transmission mode interface application 130 can be integrated with and/or within other vehicle 102 related software user interfaces or web based application user interfaces that reside on or are accessed via the wearable computing device 120. In alternate embodiments, the vehicle transmission mode interface application 130 can be used as a plug-in/add-on to software that is utilized by another application corresponding to vehicle controls/environment that is executed on the wearable computing device 120. As a plug-in/add-on, the vehicle transmission mode interface application 130 can be automatically enabled when the other application corresponding to vehicle controls/environment is initialized by the user.

The vehicle transmission mode interface application 130 can include various modules, discussed in detail below, that are controlled and operated by the processor 122 of the wearable computing device 120. In addition, the vehicle transmission mode interface application 130 can include a variety of user interfaces that can be executed on a variety of operating systems and hardware. For example, the vehicle transmission mode interface application 130 can be executed on a Google's Glass™ wearable computing device 120 and can utilize user interfaces and menus corresponding to Google's Android™ operating system platform. Additionally, the vehicle transmission mode interface application 130 can utilize Glass™ hardware components such as a prism display, built in speaker, touch-sensitive strip, camera, and microphone. The vehicle transmission mode interface application 130 can also utilize specific features of the Glass™ or any other wearable computing device 120 operating system, software, and hardware for displaying specific user interfaces and features.

In an exemplary embodiment, the functionality associated with the vehicle transmission mode interface application 130 can be presented through a graphical user interface that can be fully or partially presented to the user through the optical display 126 of the wearable computing device 120. For example, when presenting a fully presented graphical user interface, an application specific augmented and/or virtual view of the environment is shown to the user. However, when presenting a partially presented graphical user interface, a device specific (i.e., operating system and/or device specific application) graphical user interface can be utilized to partially present aspects of the augmented and/or virtual view of the environment that is shown to the user. For example, with respect to the partially presented graphical user interface, when displaying points of interests, the vehicle transmission mode interface application 130 can utilize the Glass™ default point of interest graphical user interface(s) as provided by Google Inc. while presenting a partially presented graphical user interface corresponding to the vehicle transmission mode interface application 130. In an exemplary embodiment, the fully or partially presented graphical user interface is presented to the user based on the specific type of wearable computing device 120 (i.e., hardware, brand, model, operating system, default software, etc.)

In an exemplary embodiment, the vehicle transmission mode interface application 130 can enable a driver of the vehicle 102 to view an augmented and/or a virtual reality image that assists the driver and/or provides the driver with graphical information that is relevant to the driver with respect to each transmission mode. In most transmission modes, the vehicle transmission mode interface application 130 ensures that it can only be utilized when it is being operated by the driver as oppose to passengers of the vehicle 102. Accordingly, the vehicle transmission mode interface application 130 can include a classification module 132 that classifies the user of the wearable computing device 120 based on the position of the wearable computing device 120 within the vehicle 102.

In one embodiment, the classification module 132 utilizes a plurality of sensors (not shown) included as part of the wearable computing device 120 to identify a user classification category of a user associated with the wearable computing device 120. The plurality of sensors can include but are not limited to an accelerometer, a magnetometer, a gyroscope, an ambient light sensor, a proximity sensor, a global positioning sensor system, a back illuminated sensor and the like. The plurality of sensors can be utilized in conjunction with one or more cameras of the wearable computing device 120 to localize the wearable computing device 120 within the vehicle 102.

In an exemplary embodiment, the classification category identified by the classification module 132 is one of a driver or a passenger. The classification module 132 identifies the user associated with the wearable computing device to determine the interfaces and/or applications that are presented to the user. The user classification category can be based on at least one of localizing the position of the wearable computing device and evaluating a device id that corresponds to the wearable computing device.

With regards to localizing the position of the wearable computing device 120, the classification module 132 localizes the position of the wearable computing device 120 by determining the location of a predetermined virtual marker within the vehicle 102 that is found in vehicle logic. The predetermined virtual marker can be a central focal point that is used to locate the wearable computing device 120 within a specific area within the vehicle 102. The one or more cameras of the wearable computing device 120 are utilized to capture one or more images of the vehicle 102 from the user's frame of reference upon execution of the vehicle transmission mode interface application 130. The processor 122 accesses vehicle logic that includes vehicle imagery data. The processor 122 determines that the captured image is of the vehicle 102 by comparing the captured image data to the vehicle imagery data. As the image of the vehicle 102 is captured by the one or more cameras, the processor 122 accesses the vehicle logic and determines the position of the predetermined marker that is located within the image based on the vehicle logic.

Once the predetermined marker is positioned, the classification module 132 determines the specific orientation of the wearable computing device 120 by utilizing the gyroscope and accelerometer that are included within the plurality of sensors as discussed above. This determination can take place by calibrating and identifying the location of the predetermined marker as a focal point within the image. For example, the position of the predetermined marker can be detected within the vehicle logic data to be at the center of a steering wheel of the vehicle 102. Once the user wearing the wearable computing device 120 turns his or her head and captures an image of the front panel of the vehicle 102, the processor 122 accesses the vehicle logic (located within the memory 124) and determines the location of the predetermined marker within the image.

The classification module 132 determines the position of the wearable computing device 120 and classifies the user as a driver or passenger based on the determined position of the wearable computing device 120 within the vehicle 102. For example, if the predetermined marker is found at the center of the steering wheel, the classification module 132 can localize the position of the wearable computing device 120 relative to the center of the steering wheel. This determination can depend on the specific orientation of the wearable computing device 120 as provided by the gyroscope and accelerometer as the user looks about the vehicle 102 and the wearable computing device 120 is being panned to capture images around the vehicle 102.

In another embodiment, the classification module 132 identifies the user classification category based on evaluating a device ID that corresponds to the wearable computing device 120. The device ID can be associated with a driver or a passenger. Thus, the classification module 132 can receive the device ID from the wearable computing device 120 (e.g., the vehicle transmission mode interface application 130) and determine whether the device ID is associate with a driver and a passenger. In some embodiments, the determination can be made by querying a database with the device ID and/or using a look-up table to determine whether the device ID is associated with a driver or a passenger.

The user classification category can be used to control operation of the wearable computing device 120. In an exemplary embodiment, in most transmission modes except for the park (P) and neutral (N) transmission modes, the vehicle transmission mode interface application 130 only allows the display of specific user interfaces through the optical display 126 of the wearable computing device 120 once it is determined that the user is a driver of the vehicle 102 based on the user classification category. In an alternate embodiment, in addition of the providing the driver with features that correspond to the transmission modes of the vehicle 102, the vehicle transmission mode interface application 130 can also be utilized to allow the passenger to utilize separate interfaces, and/or applications that correspond to vehicle systems that are irrespective of the transmission mode of the vehicle 102. Specifically, the classification module 132 is utilized to determine the interfaces and/or applications that are presented to the user based on the user classification category.

The vehicle transmission mode interface application 130 can also include a transmission determinant module 134 to determine a transmission mode of the vehicle 102. In one embodiment, the transmission mode determinant module 134 determines the transmission mode of the vehicle from one more mode transmission modes by connecting to and communicating with at least one of a vehicle electronic control unit, a vehicle engine control unit, and a vehicle transmission control unit. The transmission mode determinant module 134 can receive a transmission control mode code from said units that corresponds to the transmission mode of the vehicle 102. As an illustrative example, the electronic control unit 104 communicates directly with the engine control unit 106 and/or the transmission control unit to determine the transmission mode of the vehicle 102 at any given time. The electronic control unit 104 registers the real time transmission mode and sends a transmission control mode code to the transmission determinant module 134.

As mentioned above, the electronic control unit 104 can provide a transmission control mode code that corresponds to the transmission mode. The transmission control mode code can consist of an alpha-numeric code that corresponds to various automatic transmission modes. For example, the code for the park transmission mode can be P and the code for the second drive transmission mode can be D2. The transmission determinant module 134 interprets the code received from the electronic control unit 104 and sends the transmission mode data to an optical display module 136. Generally, the optical display module 136 controls the operation of the wearable computing device 120 based on the user classification category and the transmission mode of the vehicle. For example, the optical display module 136 can receive the transmission mode of the vehicle 102 and present information that corresponds to one or more transmission modes to be displayed to the user through the optical display 126 on the wearable computing device 120. Such information can selectively include the utilization of applications, interfaces that correspond to vehicle systems, software features, and/or hardware features to access other applications and functions on the wearable computing device 120.

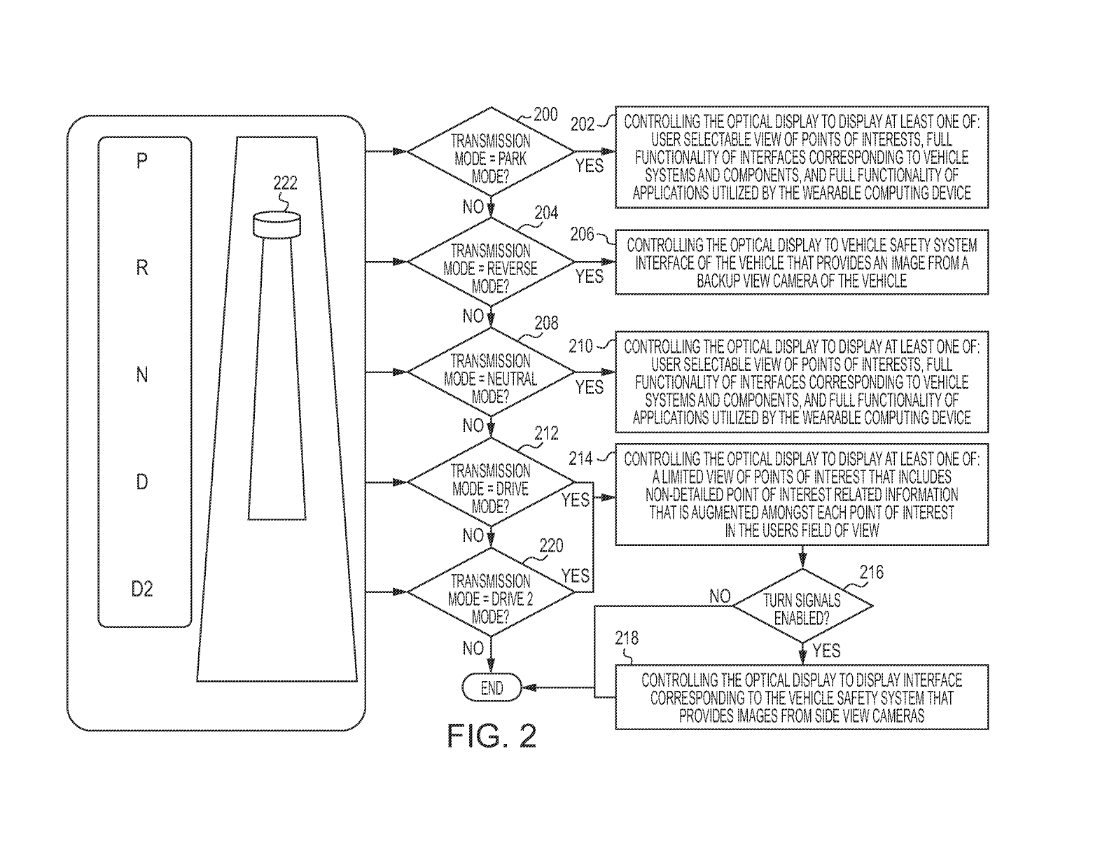

Referring now to FIG. 2, a process flow diagram of a method utilized by an exemplary embodiment of the transmission determinant module 134 of FIG. 1 to determine a transmission mode of the vehicle 102 and the optical display module 136 of FIG. 1 to control the optical display 126 of the wearable computing device 120 is illustrated. Further, FIG. 2 illustrates a schematic view of a transmission shift lever 222 that can be included in the vehicle 102. For example, a user (e.g., a driver) can put the vehicle 102 into different transmission modes by moving the transmission shift lever 222.

In the method of FIG. 2, a specific order of determining transmission modes are shown (i.e., P, R, N, D, D2), however, it is understood that the method and systems described herein can determine transmission modes in any order.

In one embodiment, if the transmission shift lever 222 of the vehicle 102 is in the park (P) mode, the electronic control unit 104 can communicate the transmission mode code associated with the park (P) transmission mode (e.g., ‘P’) to the transmission determinant module 134. Upon determining the transmission mode of the vehicle 102 is the park (P) transmission mode, the transmission determinant module 134 sends the transmission mode data to the optical display module 136. Specifically, at block 202, the method includes controlling an optical display 126 of the wearable computing device 120 to the display at least one of a user selectable view of points of interest that includes detailed point of interest related information that is augmented amongst each point of interest in the users field of view and full functionality of interfaces corresponding to vehicle systems and components and full functionality of applications utilized by the wearable computing device.

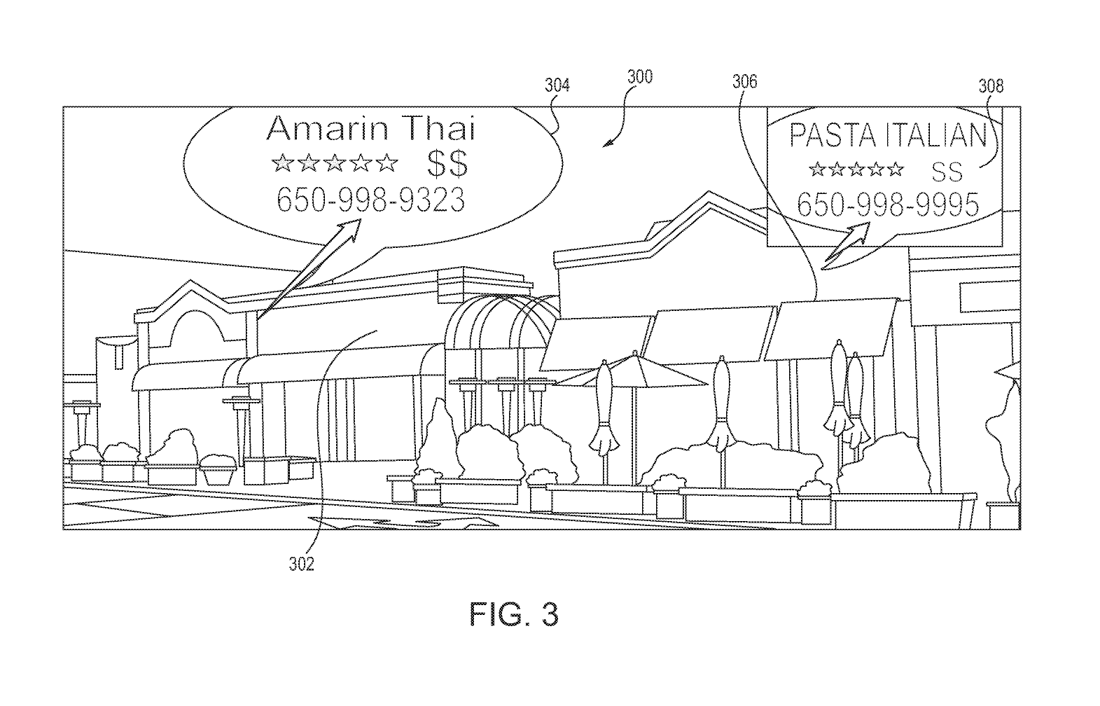

With reference to FIG. 3, a screenshot of an exemplary optical display of a wearable computing device providing point of interest user interface according to one embodiment. Specifically, FIG. 3 illustrates exemplary screenshot of the optical display 126 of the wearable computing device 120 providing a point of interest user interface 300 showing points of interests displayed by the optical display module 136. In an exemplary embodiment, during the park (P) transmission mode, the optical display module 136 can provide the point of interest user interface 300 that are augmented to present a user interface with real images of points of interests 302, 306 that include augmented point of interest information 304, 308 that are presented to the user in his or her field of vision. As will be described below, in one embodiment, the optical display module 136 can also provide the point of interest user interface 300 during the neutral (N) transmission mode. The point of interest information can consist of a point of interest name, category, and description of the points of interest in regards to the type of establishment. Such information can include but is not limited to food, lodging, transportation, emergency services, etc.

Referring back to FIG. 1, in another embodiment, the wearable computing device 120 utilizes installed software or third party developed software to present the user with points of interest data related to all points of interests that are present in the driver's field of vision. For example, if the user is utilizing Google's Glass™ to execute the vehicle transmission mode information application 130 during the park (P) transmission mode, the default Glass™ navigation/point of interest application can be presented by the optical display module 136 in order to provide users with points of interest information.

In the park (P) transmission mode, the optical display module 136 allows the execution of applications on the wearable computing device 120 and the display of interfaces that correspond to selected vehicle systems and vehicle components. For example, the optical display module 136 can allow the user to gain access to a vehicle video system user interface, and restrict access to certain vehicle safety system 110 user interfaces. In one embodiment, the user can utilize specific applications that are executed from the wearable computing device 120 that link to vehicle systems. For example, when the vehicle 102 is in the park (P) transmission mode, the driver can execute an installed gaming application that links to the internet to provide gaming related user interfaces via the optical display 126 of the wearable computing device 120.

In addition to applications, the driver is able to utilize various hardware features that can be included as part of the wearable computing device 120 and software features that are installed within the memory 124 or accessed by the communication device 128 of the wearable computing device 120. In other words, when the vehicle 102 is in the park (P) transmission mode, the user can freely utilize the applications, features, and interfaces that are being executed by the wearable computing device 120 without any applications, features, and interfaces being locked out or inaccessible due to driving safety.

Referring again to FIG. 2, at block 204, if it is determined that by the transmission determinant module 134 that the transmission mode is not in the park (P) transmission mode (at block 200), the transmission determinant module 134 determines if the vehicle 102 is in the reverse (R) transmission mode. In an exemplary embodiment, when the transmission shift lever of the vehicle 102 is in the reverse (R) mode, the electronic control unit 104 can communicate the transmission mode code associated with the reverse (R) transmission mode (e.g., ‘R’) transmission determinant module 134. If it is determined that the vehicle 102 is in the reverse (R) transmission mode, the transmission determinant module 134 sends the transmission mode data to the optical display module 136. At block 206, the method includes controlling the operation of the wearable computing device 120 comprises controlling an optical display 126 of the wearable computing device 120 to display a vehicle safety system interface of the vehicle 102 that provides an image from a backup view camera of the vehicle 102.

In one embodiment, upon the transmission determinant module 134 receiving the transmission mode code associated with the reverse (R) transmission mode, a signal is sent to the optical display module 136. The optical display module 136 utilizes the communication device 128 of the wearable computing device 120 to communicate directly with the vehicle safety system 110 and/or the electronic control unit 104 through the communication device 112 of the vehicle 102 to access backup view camera data. The backup view camera data is utilized by the vehicle safety system 110 to present the backup camera view within the vehicle 102 when the driver is reversing the vehicle 102. The optical display module 136 augments the real world image that is displayed through the optical display 126 of the wearable computing device 120 with an image of the backup view camera showing the driver the real time backup view as the vehicle 102 in being reversed. In an exemplary embodiment, when it is determined that the vehicle 102 is in the reverse (R) transmission mode, the optical display module 136 restricts access to (i.e., locks out) all non-essential (those deemed not essential to driving) hosted applications, interfaces linked to vehicle systems, features, and external applications from being accessed by the driver to ensure driving safety while the vehicle 102 is in the reverse (R) transmission mode.

At block 208, if it is determined that by the transmission determinant module 134 that the transmission mode is not in the reverse (R) transmission mode (at block 204), the transmission determinant module 134 determines if the vehicle 102 is in the neutral (N) transmission mode. In an exemplary embodiment, when the transmission shift lever of the vehicle 102 is in the neutral (N) mode, the electronic control unit 104 can communicate the transmission mode code as N to the transmission determinant module 134. If it is determined that the vehicle 102 is in the neutral (N) transmission mode, the transmission determinant module 134 sends the transmission mode data to the optical display module 136.

At block 210, the method includes controlling an optical display 126 of the wearable computing device 120 to the display at least one of a user selectable view of points of interest that includes detailed point of interest related information that is augmented amongst each point of interest in the users field of view and full functionality of interfaces corresponding to vehicle systems and components and full functionality of applications utilized by the wearable computing device 120. As described above, with reference to FIG. 3, the optical display module 136 can present the driver with the points of interest interface 300 that augments real images of points of interests 302, 306 that include augmented point of interest information 304, 308 that are present in the driver's field of vision.

In an exemplary embodiment, when it is determined that the transmission mode is the neutral (N) transmission mode, the optical display module 136 also allows the execution and display of interfaces that correspond to vehicle systems and various applications hosted on (installed within the memory 124) and/or accessed by (accessed by the communication device 128) the wearable computing device 120. In addition, in the neutral (N) mode, the optical display module 136 allows the driver to utilize various hardware features that can be included as part of the wearable computing device 120. Additionally, the optical display module 136 allows the driver to utilize web based features that are accessed by wearable computing device 120. In other words, similarly to when the vehicle 102 is in the park (P) transmission mode, the optical display module 136 allows the user to freely utilize the applications, features, and interfaces that are being executed by the wearable computing device 120 without any applications, features, and interfaces being locked out or inaccessible due to driving safety.

When the vehicle 102 is in the neutral (N) transmission mode, there is a likelihood that the driver is not present within the vehicle 102. For example, the vehicle 102 can be put into the neutral (N) transmission mode in order for the vehicle 102 to be towed. In such a circumstance, the vehicle transmission mode interface application 130 can provide the driver with access to interfaces that correspond to vehicle systems and vehicle components. In an exemplary embodiment, the vehicle navigation system, 108 includes a global positioning sensor (not shown) that tracks, records, and utilizes the global position of the vehicle 102. In one embodiment, when it is determined by the transmission determinant module 134, that the vehicle 102 is in the neutral (N) transmission mode, the optical display module 136 communicates with the classification module 132 to determine if the user of the wearable computing device 120 is located within the vehicle 102.

In one embodiment, the classification module 132 determines if the predetermined marker is located at a designated location within the vehicle 102 (e.g., the center of the steering wheel) is found. If the classification module 132 determines that the predetermined marker is not found, and the transmission determinant module 134 determines that the vehicle 102 is in the neutral (N) transmission mode, the optical display module 136 provides the user with the interface corresponding to the vehicle navigation system 108. Specifically, upon the transmission determinant module 134 receiving the transmission mode code associated with the neutral (N) transmission mode, a signal is sent to the classification module 132 to determine if the user wearing the wearable computing device 120 is located within the vehicle 102.

When it is determined that the user is not within the vehicle 102 during the neutral (N) transmission mode, the optical display module 136 utilizes the communication device 128 of the wearable computing device 120 to communicate with the vehicle navigation system 108 via the communication device 128 of the vehicle 102. The optical display module 136 can present the user with an image of a map showing the tracked location (via GPS) of the vehicle 102 as its being towed or arrives at its destination. In one embodiment, the image of the map is part of the vehicle navigation system 108 user interface or a map interface that is included as a default application of the vehicle transmission mode interface application 130. In an alternate embodiment, the map interface can be an installed mapping program that is installed within the memory 124 of the wearable computing device 120 or externally hosted and accessible by the wearable computing device 120.

With reference back to FIG. 2, at block 212, if it is determined by the transmission determinant module 134 that the transmission mode is not the neutral (N) transmission mode (at block 206), the transmission determinant module 134 determines if the vehicle 102 is in the drive (D) transmission mode. In an exemplary embodiment, when the transmission shift lever of the vehicle 102 is in the drive (D) mode, the electronic control unit 104 can communicate the transmission mode code associated with the drive (D) transmission mode (e.g., ‘D’) to the transmission determinant module 134. If it is determined that the vehicle 102 is in the drive (D) transmission mode, the transmission determinant module 134 sends the transmission mode data to the optical display module 136.

At block 214, the method includes, controlling the optical display 126 of the wearable computing device 120 to display at least one of a limited view of points of interest that includes non-detailed point of interest related information that is augmented amongst each point of interest in the users field of view. In an exemplary embodiment, the method additionally includes controlling the optical display 126 of the wearable computing device 120 to display at least one of a vehicle safety system interface that provides an image from a backup view camera of the vehicle 102 and limited application functionality utilized by the wearable computing device. Specifically, when it is determined that the vehicle 102 is in the drive (D) transmission mode, the optical display module 136 restricts access to (i.e., locks out) all non-essential (those deemed not essential to driving) hosted applications, interfaces linked to vehicle systems, features, and external applications from being accessed by the driver to ensure driving safety. The driver is presented limited non-detailed augmented point of interest information that are present in the driver's field of vision. Unlike the point of interest information presented to the driver during the park (P) and neutral (N) transmission modes, that can consist of point of interest name, category, and descriptive information, the point of interest information presented to the driver during the drive (D) transmission mode can only include a point of interest name. The limited point of interest information ensures less driver distraction as the driver is driving the vehicle 102.

The optical display module 136 can also present the driver with the image of the backup view camera through the optical display 126 as desired by the driver. For example, the driver can view the image from the backup view camera when changing lanes in lieu of using the rear view and/or side view mirrors of the vehicle 102. Additionally, the optical display module 136 can provide the driver with limited access to interfaces corresponding to user selected vehicle systems and components. In an exemplary embodiment, the optical display module 136 can present the driver with the interface corresponding to the vehicle navigation system 108. The interface can present the driver with an augmented view of turn by turn directions that are displayed through the optical display 126 of the wearable computing device 120. In one embodiment, the driver can be shown an image of the map showing the tracked location (via GPS) of the vehicle 102 and turn by turn driving directions. In an alternate embodiment, the driver can be shown an augmented image of the road ahead of the driver with arrows designating turn by turn directions shown (augmented) above or in front of the driver. Speakers (not shown) included as part of the wearable computing device 120 or the speakers included within the vehicle 102 can also be utilized to provide audio based turn by turn navigation directions that correspond to the visual directions being shown through the optical display 126. In an alternate embodiment, other vehicle system interfaces can be presented to the driver in a limited fashion. For example, the driver can access the interface corresponding to the infotainment system, but may only be able to access limited functionality such as selecting radio station presets or audio tracks.

While the vehicle 102 is in the drive (D) or second drive (D2) transmission modes, at block 216, it is determined if the vehicle turn signals are enabled by the driver. At block 218, if it is determined that the turn signals are enabled by the driver, the method includes controlling the optical display 126 of the wearable computing device 120 to display to the interface corresponding to the vehicle safety system 110 that provides images from side view cameras. In one embodiment, upon the transmission determinant module 134 receiving the transmission mode code associated with the drive transmission mode, a signal is sent to the optical display module 136 to provide interfaces corresponding to the drive (D) transmission mode. The optical display module 136 utilizes the communication device 128 of the wearable computing device 120 to constantly communicate with the vehicle safety system 110 and/or the electronic control unit 104 through the communication device 112 of the vehicle 102 to determine when each of the (right or left side) vehicle turn signals are enabled. Upon enabling of the turn signals, the optical display module 136 accesses the vehicle safety system 110 to acquire side view camera data that is utilized by the vehicle safety system 110 to present a lane assist and/or blind spot monitoring assist function to the driver.

The optical display module 136 augments the real world image that is seen by the user wearing the wearable computing device 120 with an image of the side view camera that corresponds to the turn signal that is enabled showing the driver the real time side view as the car in being driven. For example, if the driver has enabled the left hand side turn signal, the optical display module 136 can present the driver with the image of the left hand side view camera that assists the driver with turning or changing lanes. If it is determined that either of the turn signals are not enabled (at block 214) and the vehicle 102 is in the drive (D) transmission mode or second drive (D2) transmission mode, the driver is presented with interfaces that correspond to the drive (D) transmission or second drive (D2) transmission modes. In an alternate embodiment, while the vehicle 102 is in the drive (D) transmission mode, the user also has the option of initializing some limited application interfaces that correspond to vehicle systems. For example, the user can utilize limited interfaces corresponding to the vehicle HVAC system, the vehicle audio system, the vehicle infotainment system, and the vehicle telephone system

At block 220, if it is determined by the transmission determinant module 134 that the transmission mode is not the drive (D) transmission mode (at block 208), the transmission determinant module 134 determines if the vehicle 102 is in the second drive (D2) transmission mode. If it is determined that the vehicle 102 is in the second drive (D) transmission mode, the transmission determinant module 134 sends the transmission mode data to the optical display module 136. As discussed above, at block 210, the optical display module 136 selectively displays an interface that presents limited view of points of interests, and limited interfaces corresponding to user selected vehicle systems and components. In an alternate embodiment, the optical display module 136 can present alternate interfaces to the user from the drive (D) transmission mode interfaces.

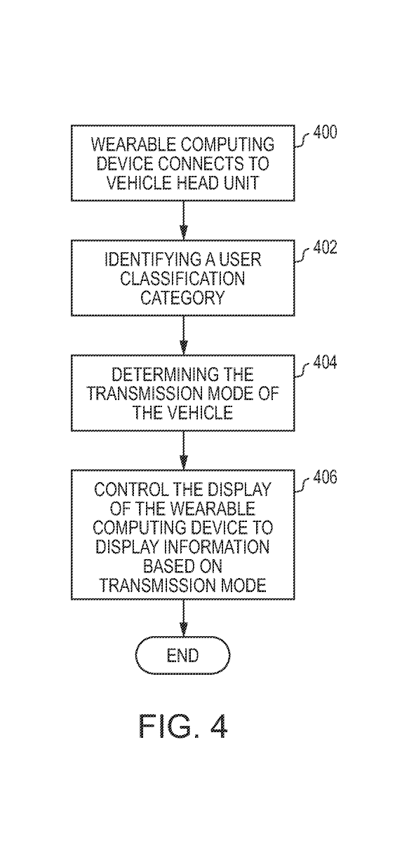

Referring now to FIG. 4, the system and methods of FIGS. 1-2 described above will now be described in operation with reference to a method of FIG. 4 for controlling an operation of a wearable computing device based on one or more transmission modes of a vehicle. Specifically, FIG. 4 illustrates a process flow diagram of a method utilized by an exemplary embodiment of the vehicle transmission mode information application 130 for controlling the operation of the wearable computing device 120 based on one or more transmission modes of the vehicle 102 from the operating environment of FIG. 1. At block 400, the method includes communicating with the wearable computing device. Communicating with the wearable computing device can include connecting the wearable computing device to the vehicle allowing the wearable computing device to communicate at least one of vehicle system data, vehicle transmission data, and transmission mode application data.

More specifically, and with reference to FIG. 1, the wearable computing device 120 connects to the vehicle head unit 114 to access and execute the vehicle transmission mode interface application 130. In one embodiment, the command to access and execute the vehicle transmission mode interface application 130 can occur automatically when the communication device 128 of the wearable computing device 120 establishes a wireless connection (vie Bluetooth™) with the communication device 112 of the vehicle 102. For example, a wireless connection can be established when the driver puts the vehicle in an accessory (ACC) ON state, or an ignition (engine) ON state. In an alternate embodiment, the driver can provide the actuation command to access and execute the vehicle transmission interface application 130 to be utilized when the user (i.e., driver) desires.

At block 402, the method includes identifying the user classification category is one of a driver or a passenger and identifying a user classification category that includes identifying a user associated with the wearable computing device to determine the interfaces or applications that are presented to the user, wherein identifying the user classification category is based on at least one of: localizing the position of the wearable computing device and evaluating a device ID that corresponds to the wearable computing device.

As discussed above, in one embodiment, the classification module 132 can utilize a plurality of sensors included as part of the wearable computing device 120 that can include but are not limited to an accelerometer, a magnetometer, a gyroscope, a proximity sensor, a global positioning sensor system, along with the one or more cameras of the wearable computing device 120 to localize the wearable computing device 120 within the vehicle 102. In an alternate embodiment, as discussed above, the device ID is evaluated by the classification module 132 to determine if the user classification category is a driver or a passenger.

At block 404, the method includes determining a transmission mode of the vehicle, wherein determining the transmission mode of the vehicle includes receiving a transmission control mode code from at least one of: a vehicle electronic control unit, a vehicle engine control unit, and a vehicle transmission control unit of the vehicle, wherein the transmission control mode code corresponds to the transmission mode of the vehicle. More specifically, the transmission determinant module 134 can determine the transmission mode of the vehicle 102 by receiving the transmission control mode code from at least one of: the vehicle electronic control unit, the vehicle engine control unit, and the vehicle transmission control unit.

In one embodiment, the transmission determinant module 134 utilizes the communication device 128 to communicate directly with the electronic control unit 104 of the vehicle 102 to receive the transmission mode code for the transmission mode of the vehicle 102. In an alternate embodiment, the electronic control unit 104 utilizes the communication device 112 of the vehicle 102 to send a signal with the transmission mode control mode when the vehicle 102 is put into an ACC ON mode, an ignition ON mode, or the driver's shifts the gear shifter to change to a different transmission mode. In yet an alternate embodiment, the transmission determinant module 134 can communicate directly with the engine control unit 106 and/or the transmission control unit of the vehicle 102 to determine the transmission mode of the vehicle 102.

At block 406, the method includes controlling the operation of the wearable computing device based on the user classification category and the transmission mode of the vehicle, wherein controlling the operation of the wearable computing device comprises controlling the optical display 126 of the wearable computing device 120 to present information based on the transmission mode of the vehicle 102. As discussed above with FIG. 2, the information can selectively include the utilization of applications, interfaces that correspond to vehicle systems, software features, hardware features, and the like, based on the transmission mode of the vehicle 102.

As discussed above, various embodiments of the vehicle transmission mode wearable interface system 100 can be utilized for the driver to utilize features corresponding to the transmission modes of the vehicle 102. In addition, numerous components and technologies that have not been discussed herein can be utilized to compute operations associated with the vehicle transmission mode interface application 130. It is to be appreciated that that in addition of the wearable computing device 120, the vehicle transmission mode interface application 130 can be utilized on and/or with different types of devices that are in production and that are not yet in production. For example, the vehicle transmission mode interface application 130 can be installed and utilized by connecting to a (alternate or secondary) heads up display or center stack display that is presented within the vehicle 102.

The embodiments discussed herein may also be described and implemented in the context of non-transitory computer-readable storage medium storing computer-executable instructions. Non-transitory computer-readable storage media includes computer storage media and communication media. For example, flash memory drives, digital versatile discs (DVDs), compact discs (CDs), floppy disks, and tape cassettes. Non-transitory computer-readable storage media may include volatile and nonvolatile, removable and non-removable media implemented in any method or technology for storage of information such as computer readable instructions, data structures, modules or other data. Non-transitory computer readable storage media excludes transitory and propagated data signals.

It can be appreciated that various implementations of the above-disclosed and other features and functions, or alternatives or varieties thereof, can be desirably combined into many other different systems or applications. Also that various presently unforeseen or unanticipated alternatives, modifications, variations, or improvements therein can be subsequently made by those skilled in the art which are also intended to be encompassed by the following claims.

1. A method for controlling an operation of a wearable computing device based on one or more transmission modes of a vehicle, comprising:
communicating with the wearable computing device;
identifying a user classification category;
determining a transmission mode of the vehicle; and
controlling the operation of the wearable computing device based on the user classification category and the transmission mode of the vehicle.

2. The method of claim 1, wherein communicating with the wearable computing device comprises connecting the wearable computing device to the vehicle allowing the wearable computing device and the vehicle to communicate at least one of: vehicle system data, vehicle transmission data, vehicle engine data, and transmission mode application data.

3. The method of claim 1, wherein the user classification category is one of a driver or a passenger and identifying a user classification category comprises identifying a user associated with the wearable computing device to determine the interfaces or applications that are presented to the user, wherein identifying the user classification category is based on at least one of: localizing the position of the wearable computing device and evaluating a device ID that corresponds to the wearable computing device.

4. The method of claim 1, wherein determining the transmission mode of the vehicle comprises receiving a transmission control mode code from at least one of: a vehicle electronic control unit, a vehicle engine control unit, and a vehicle transmission control unit of the vehicle, wherein the transmission control mode code corresponds to the transmission mode of the vehicle.

5. The method of claim 1, wherein controlling the operation of the wearable computing device comprises controlling an optical display of the wearable computing device to present information based on the transmission mode of the vehicle.

6. The method of claim 1, wherein the transmission mode of the vehicle is at least one of: a park (P) transmission mode, a reverse (R) transmission mode, a neutral (N) transmission mode, one or more drive (D) transmission modes, an emergency brake (B) mode, a snow mode (S), a sport mode (SPT) and a manual transmission gear mode.

7. The method of claim 6, wherein upon determining the transmission mode is the park (P) transmission mode or the neutral (N) transmission mode, controlling the operation of the wearable computing device comprises, controlling an optical display of the wearable computing device to display at least one of a user selectable view of points of interest that includes detailed point of interest related information that is augmented amongst each point of interest in the users field of view and full functionality of interfaces corresponding to vehicle systems and components and full functionality of applications utilized by the wearable computing device.

8. The method of claim 6, wherein upon determining the transmission mode is the reverse (R) transmission mode, controlling the operation of the wearable computing device comprises controlling an optical display of the wearable computing device to display a vehicle safety system interface of the vehicle that provides an image from a backup view camera of the vehicle.

9. The method of claim 6, wherein upon determining the transmission mode is one or more drive (D) transmission modes, controlling the operation of the wearable computing device comprises controlling an optical display of the wearable computing device to display at least one of a limited view of points of interest that includes non-detailed point of interest related information that is augmented amongst each point of interest in the users field of view and the interface corresponding to the vehicle safety system that provides images from side view cameras based on enabling of a turn signal.

10. The method of claim 6, wherein upon determining the transmission mode is one or more drive (D) transmission modes, controlling the operation of the wearable computing device comprises controlling an optical display of the wearable computing device to display at least one of a vehicle safety system interface that provides an image from a backup view camera of the vehicle and limited application functionality utilized by the wearable computing device.

11. A system of controlling an operation of a wearable computing device based on one or more transmission modes of a vehicle comprising:
a vehicle transmission mode interface application that is executed on the wearable computing device and is operably connected for computer communication with the vehicle, the vehicle transmission mode interface application including:
a classification module that identifies a user classification category of a user associated with the wearable computing device;
a transmission mode determinant module that determines a transmission mode of the vehicle; and
an optical display module that controls the operation of the wearable computing device based on the user classification category and the transmission mode of the vehicle.

12. The system of claim 11, wherein the wearable computing device and the vehicle are operably connected for computer communication to communicate at least one of: vehicle system data, vehicle transmission data, vehicle engine data, and vehicle transmission mode interface application data.

13. The system of claim 11, wherein the user classification category is one of a driver or a passenger and the classification module identifies the user associated with the wearable computing device to determine the interfaces or applications that are presented to the user, wherein the classification module identifies the user classification category based on at least one of: localizing the position of the wearable computing device and evaluating a device ID that corresponds to the wearable computing device.

14. The system of claim 11, wherein the transmission mode determinant module determines the transmission mode of the vehicle from one or more transmission modes by connecting to and communicating with at least one of: the vehicle electronic control unit, the vehicle engine control unit, and a vehicle transmission control unit, and receiving from said units a transmission control mode code that corresponds to the transmission mode.

15. The system of claim 11, wherein the optical display module controls the operation of the wearable computing device by controlling an optical display of the wearable computing device to present information that corresponds to one or more transmission modes, wherein the optical display module displays the information on the optical display based on at least one of: a park (P) transmission mode, a reverse (R) transmission mode, a neutral (N) transmission mode, one or more drive (D) transmission modes, an emergency brake (B) mode, a snow mode (S), a sport mode (SPT), a turn signal operation mode, and a manual transmission gear mode.

16. The system of claim 15, wherein upon determining the transmission mode is the park (P) transmission mode or the neutral (N) transmission mode, the optical display module controls the operation of the wearable computing device by controlling the optical display to present at least one of: a user selectable view of points of interest that includes detailed point of interest related information that is augmented amongst each point of interest in the users field of view, full functionality of interfaces corresponding to vehicle systems and components and full functionality of applications utilized by the wearable computing device.

17. The system of claim 15, wherein upon determining the transmission mode is the reverse (R) transmission mode, the optical display module controls the operation of the wearable computing device by controlling the optical display to present an image from a backup view camera of the vehicle.

18. The system of claim 15, wherein upon determining the transmission mode is one or more drive (D) transmission modes, the optical display module controls the operation of the wearable computing device by controlling the optical display to present at least one of: a limited view of points of interest that includes non-detailed point of interest related information that is augmented amongst each point of interest in the users field of view, the interface corresponding to a vehicle safety system that provides images from side view cameras based on enabling of a turn signal.

19. The system of claim 15, wherein upon determining the transmission mode is one or more drive (D) transmission modes, the optical display module controls the operation of the wearable computing device by controlling the optical display to present at least one of: the interface corresponding to a vehicle safety system that provides an image from a backup view camera of the vehicle and limited application functionality utilized by the wearable computing device.

20. A non-transitory computer readable medium comprising instructions that when executed by a processor performs actions comprising:
communicating with a wearable computing device;
identifying a user classification category;
determining a transmission mode of the vehicle; and
controlling the operation of the wearable computing device based on the user classification category and the transmission mode of the vehicle.
